(19) United States
(12) Patent Application Publication
(10) Pub. No.: US 2001/0008712 A1
(43) Pub. Date: Jul. 19, 2001

(54) Thin film magnetic head

(76) Inventors: Hisayuki Yazawa, Niigata-ken (JP); Yoshihiro Kanada, Niigata-ken (JP)

Correspondence Address: Gustavo Siller, Jr., Brinks Hofer Gilson & Lione, P. O. Box 10395, Chicago, IL, 60610, US

(21) Appl. No.: 09/795,260

(22) Filed: Feb. 28, 2001

Related U.S. Application Data
(62) Division of application No. 09/469,603, filed on Dec. 21, 1999.

(30) Foreign Application Priority Data
Dec. 22, 1998 (JP) 10-364294

(51) Int. Cl. G11B 5/39; G11B 5/31

(52) U.S. Cl. 428/692; 428/694 T

(57) ABSTRACT

A lower core layer and upper core layer are conventionally made of a CoFeNi alloy or the like having a relatively high saturation magnetic flux density, but these layers have the problem of increasing an eddy current loss due to the low resistivity of the CoFeNi alloy with a higher recording frequency. In the present invention, a lower core layer and/or upper core layer is made of a CoFeNiX (X is S, P, or the like) alloy, which has a high saturation magnetic flux density, high resistivity, and low coercive force, as compared with the CoFeNi alloy. Therefore, it is possible to manufacture a thin film magnetic head capable of complying increases in recording density and recording frequency in the future.

### BACKGROUND OF THE INVENTION

1. Field of the Invention

The present invention relates to a soft magnetic film used as, for example, a core layer of a thin film magnetic head, and particularly to a soft magnetic film having soft magnetic properties such as a high saturation flux density, high resistivity, and low coercive force, a method of producing the same, and a thin film magnetic head using the soft magnetic film.

2. Description of the Related Art

FIG. 10 is a longitudinal sectional view showing the structure of a conventional thin film magnetic head in which the left end shown in the drawing is opposed to a recording medium.

Although the thin film magnetic head shown in FIG. 10 comprises only an inductive head for writing signals on a recording medium such as a hard disk or the like, the thin film magnetic head may be a so-called combination type thin film magnetic head comprising a reproducing MR head formed below the inductive head. The thin film magnetic head is provided on the trailing-side end surface of a slider of a floating magnetic head.

In FIG. 10, reference numeral 1 denotes a lower core layer made of a high-permeability magnetic material, such as a NiFe alloy (permalloy), a magnetic gap layer 2 made of a nonmagnetic material such as Al₂O₃ (alumina) being provided on the lower core layer 1. Referring to FIG. 10, an insulating layer 3 made of a resist material or another organic resin material is formed on the magnetic gap layer 2. A coil layer 4 is spirally formed on the insulating layer 3 using.

An insulating layer 5 made of a resist material or another organic resin material is formed on the coil layer 4. Furthermore, a magnetic material such as permalloy or the like is deposited on the insulating layer 5 to form an upper core layer 6. An end of the upper core layer 6 is bonded to the lower core layer 1 with the gap layer 2 provided therebetween in a portion opposed to the recording medium to form a magnetic gap having a gap length G111. The base end 6a of the upper core layer 6 is magnetically connected to the lower core layer 1 through a hole formed in the gap layer 2 and the insulating layer 3.

In the writing inductive head, a recording current is supplied to the coil layer 4 to induce a recording magnetic field in the lower core layer 1 and the upper core layer 6 so that a magnetic signal is recorded on the recording medium such as a hard disk by a leakage magnetic field from the magnetic gap between the lower core layer 1 and the end of the upper core layer 6.

In order to improve a recording density, it is necessary to improve the soft magnetic properties of the upper core layer 6 and the lower core layer 1. Of the soft magnetic properties, a saturation magnetic flux density is preferably high. Particularly, where the upper core layer 6 has a high saturation magnetic flux density, a leakage magnetic field between the upper core layer 6 and the lower core layer 1 readily undergoes reversal of magnetization, thereby possibly further improving the recording density.

As described above, each of the upper core layer 6 and the lower core layer 1 is conventionally made of a NiFe alloy (permalloy). However, soft magnetic materials having a higher saturation magnetic flux density than the NiFe alloy include CoFeNi alloys.

Although a CoFeNi alloy has a high saturation magnetic flux density, the resistivity is as low as the same as the NiFe alloy, or lower than the resistivity of the NIFe alloy according to the composition. Therefore, with a high recording frequency, an eddy current occurs in the lower core layer 1 and the upper core layer 6, increasing a heat loss due to the eddy current.

### SUMMARY OF THE INVENTION

The present invention has been achieved for solving the above problem, and an object of the present invention is to provide a soft magnetic film in which resistivity can be improved by adding element X (sulfur or the like) to a CoFeNi alloy, a method of producing the same, and a thin film magnetic head using the soft magnetic film as a core layer to permit compliance with increases in recording density and recording frequency.

A soft magnetic film of the present invention is represented by the composition formula CoₐFe_{b}Ni_{c}X_{d} wherein element X is at least one element selected from S, P, B, C, and N, the composition ratio d of element X to all component elements is in the range of 0.5 wt % to 2 wt %, and when the remainder is 100 wt % excluding the composition ratio d, composition ratio a is in the range of more than 0 wt % and less than 40 wt %, composition ratio b is in the range of 20 wt % to 100 wt %, and composition ratio c is in the range of more than 0 wt % and less than 40 wt %.

In the present invention, the composition ratio d is preferably in the range of 1 wt % to 1.5 wt %.

In the present invention, preferably, the composition ratio a is in the range of more than 0 wt % and less than 20 wt %, the composition ratio b is in the range of 60 wt % to 100 wt %, and the composition ratio c is in the range of more than 0 wt % and less than 20 wt %.

The composition of the soft magnetic film is appropriately adjusted in the above composition ratio ranges to control the saturation magnetic flux density to 1.5 T or more, resistivity to 20 μΩ.cm or more, and coercive force to 10 Oe or less.

With a composition ratio a in the range of more than 0 wt % and less than 20 wt %, a composition ratio b in the range of 60 wt % to 100 wt %, and a composition c in the range of more than 0 wt % and less than 20 wt %, the saturation magnetic flux density of the soft magnetic film can be set to 1.7 T or more, and the coercive force can be set to 50 Oe or less.

The present invention also provides a method of producing a soft magnetic film, comprising adding thiourea (CH₄N₂S) to a plating solution containing Co ions, Fe ions, and Ni ions to contain S in the plating solution when element X which constitutes the soft magnetic film is S.

The present invention further provides a thin film magnetic head comprising a lower core layer made of a magnetic material, an upper core layer opposed to the lower core layer with a magnetic gap formed therebetween on the side facing a recording medium, and a coil layer for inducing a recording magnetic field in both core layers, wherein the upper core layer and/or the lower core layer comprises the above-described soft magnetic film.

The CoFeNi alloy conventionally used for the upper core layer and the lower core layer of the thin film magnetic head has a high saturation magnetic flux density, but it has the problem of producing an eddy current due to its low resistivity with a high recording frequency, readily increasing a heat loss due to the eddy current.

Therefore, in the present invention, a nonmetallic element X (at least one selected from S, P, B, C, and N) is further added as a fourth element to the CoFeNi alloy, to ensure a saturation magnetic flux density in the same level as or higher than that of the CoFeNi alloy and produce a soft magnetic film having higher resistivity and lower coercive force than the CoFeNi alloy.

The soft magnetic film of the present invention is represented by the composition formula CoₐFe_{b}Ni_{c}X_{d} wherein Co, Ni and Fe are elements bearing magnetism. Particularly, in order to a high saturation magnetic flux density, the Co and Fe contents are preferably as high as possible, but with excessively low Co and Fe contents, the saturation magnetic flux density is decreased. Co also has the function to increase uniaxial magnetic anisotropy.

The element X is at least one element selected from S, P, B, C, and N. These elements are nonmetallic, and thus addition of an appropriate amount of element X can improve resistivity. The addition of element X also possibly promotes decrease in the crystal grain size of the film composition, thereby decreasing coercive force. However, it was confirmed by experiment that the excessive addition of element X increases coercive force. This is possibly due to the fact that the addition of a predetermined amount of element X can promote decrease in the crystal grain size, while the addition of over the predetermined amount of element X conversely increases the size of crystal grains which constitute the film composition.

Therefore, in the present invention, on the basis of the experimental results, which will be described below, the composition ratio d of element X to all component elements is in the range of 0.5 wt % to 2 wt %, preferably 1 wt % to 1.5 wt %, in order to ensure low coercive force and high resistivity.

In the present invention, in order to maintain a high saturation magnetic flux density while ensuring good soft magnetic properties, if the remainder is 100 wt % excluding the composition ration d of element X, the composition ratio a of Co is in the range of 0 to 40 wt %, the composition ratio b of Fe is in the range of 20 wt % to 100 wt %, and the composition ratio c of Ni is in the range of 0 to 40 wt %. More preferably, the composition ratio a of Co is in the range of 0 to 20 wt %, the composition ratio b of Fe is in the range of 60 wt % to 100 wt %, and the composition ratio c of Ni is in the range of 0 to 20 wt %.

With the soft magnetic film having the above composition, it is possible to ensure a saturation magnetic flux density of 1.5 T (Tesla) or more, a resistivity of 20 μΩ.cm or more, and coercive force of 10 Oe (Orsted) or less.

The present invention uses the soft magnetic film having a high saturation magnetic flux density, high resistivity and low coercive force as a lower core layer and/or an upper core layer of a thin film magnetic head. This permits the manufacture of a thin film magnetic head capable of complying with increases in recording density and recording frequency in the future.

### BRIEF DESCRIPTION OF THE DRAWINGS

FIG. 1 is a longitudinal sectional view of a thin film magnetic head in accordance with an embodiment of the present invention;

FIG. 2 is a ternary diagram showing the relation between the composition ratio of each of Co, Fe and Ni and saturation magnetic flux density of a CoFeNiS alloy when the composition ratio S to the total composition is 1 wt %, and the remainder is 100 wt %;

FIG. 3 is a ternary diagram showing the relation between the composition ratio of each of Co, Fe and Ni and coercive force of a CoFeNiS alloy when the composition ratio S to the total composition is 1 wt %, and the remainder is 100 wt %;

FIG. 4 is a ternary diagram showing the relation between the composition ratio of each of the elements, which constitute a CoFeNi alloy, and saturation magnetic flux density;

FIG. 5 is a ternary diagram showing the relation between the composition ratio of each of the elements, which constitute a CoFeNi alloy, and coercive force;

FIG. 6 is a graph showing the relation between the amount of thiourea added and resistivity when thiurea is added to a plating solution containing Co ions, Fe ions, and Ni ions;

FIG. 7 is a graph showing the relation between the S concentration (wt %) of a soft magnetic film comprising a CoFeNiS composition and resistivity;

FIG. 8 is a graph showing the relation between the amount of thiourea added and coercive force when thiurea is added to a plating solution containing Co ions, Fe ions, and Ni ions;

FIG. 9 is a graph showing the relation between the S concentration (wt %) of a soft magnetic film comprising a CoFeNiS composition and coercive force; and

FIG. 10 is a longitudinal sectional view of a conventional thin film magnetic head.

### DESCRIPTION OF THE PREFERRED EMBODIMENT

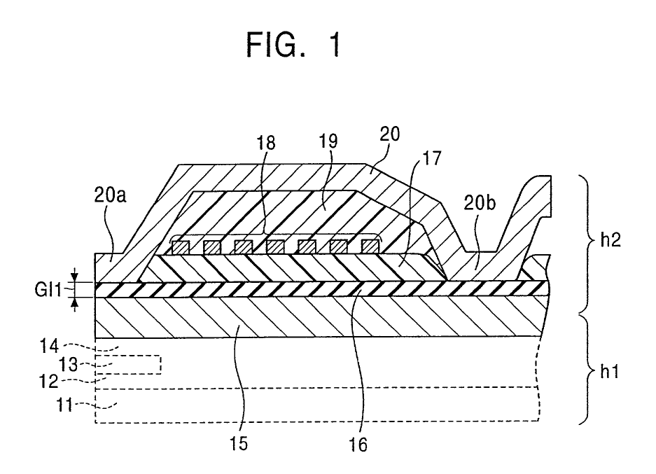

FIG. 1 is a longitudinal sectional view of a thin film magnetic head in accordance with an embodiment of the present invention. In FIG. 1, the end surface on the left side of the thin film magnetic head is opposed to a recording medium.

The thin film magnetic head of this embodiment is formed on the end surface on the trailing side of a slider which constitutes a floating head, and a MR/inductive combination thin film magnetic head (simply referred to as a “thin film magnetic head” hereinafter) comprising a lamination of a MR head h1, and a writing inductive head h2.

The MR head h1 detects a leakage magnetic field from the recording medium such as a hard disk by using a magnetoresistive effect to read recording signals. A lower shielding layer 11 made of a soft magnetic material is formed on the trailing-side end surface of the slider.

Referring to FIG. 1, a magnetoresistive element layer 13 is formed on the lower shielding layer 11 with a lower gap layer 12 formed therebetween and made of a nonmagnetic material such as Al₂O₃ (alumina). The magnetoresistive element layer 13 has an AMR structure or a GMR structure comprising a spin valve film using a giant magnetoresistive effect.

A lower core layer 15 having both the shielding function in the MR head h1 and the core function in the inductive head h2 is formed on the magnetoresistive element layer 13 with an upper gap layer 14 formed therebetween and made of a nonmagnetic material.

As shown in FIG. 1, a magnetic gap layer (nonmagnetic material layer) 16 of alumina is further formed on the lower core layer 15. A coil layer 18 patterned to a spiral planar shape is provided on the magnetic gap layer 16 with an insulating layer 17 provided therebetween and made of polyimide or a resist material. The coil layer 18 is made of a nonmagnetic conductive material having low electric resistance, such as Co (copper), or the like.

The coil layer 18 is surrounded by an insulating layer 19 made of polyimide or a resist material, an upper core layer 20 made of a soft magnetic material being formed on the insulating layer 19.

As shown in FIG. 1, an end 20a of the upper core layer 20 is opposed to the lower core layer 15 with the magnetic gap layer 16 formed therebetween to form a magnetic gap having a magnetic gap length G11 on the side facing a recording medium, the base end 20b of the upper core layer 20 being magnetically connected to the lower core layer 15.

In order to comply with increases in recording density and recording frequency in the future, and improve the writing performance of the inductive head h2, particularly, it is necessary that the upper core layer 20 comprises a soft magnetic film having soft magnetic properties such as a high saturation magnetic flux density, high resistivity, and low coercive force. Also the lower core layer 15 preferably comprises a soft magnetic film having soft magnetic properties such as high resistivity and low coercive force. Although the lower core layer 15 preferably has a high saturation magnetic flux density, it is known that the saturation magnetic flux density of the lower core layer 15 is made lower than that of the upper core layer 20 to facilitate the reversal of magnetization of a leakage magnetic field between the lower core layer 15 and the upper core layer 20, thereby increasing the signal write density of the recording medium.

In the present invention, the lower core layer 15 and/or the upper core layer 20 comprises a soft magnetic film represented by the composition formula Co-Fe-Ni-X. In the formula, element X is at least one element selected from S, P, B, C, and N.

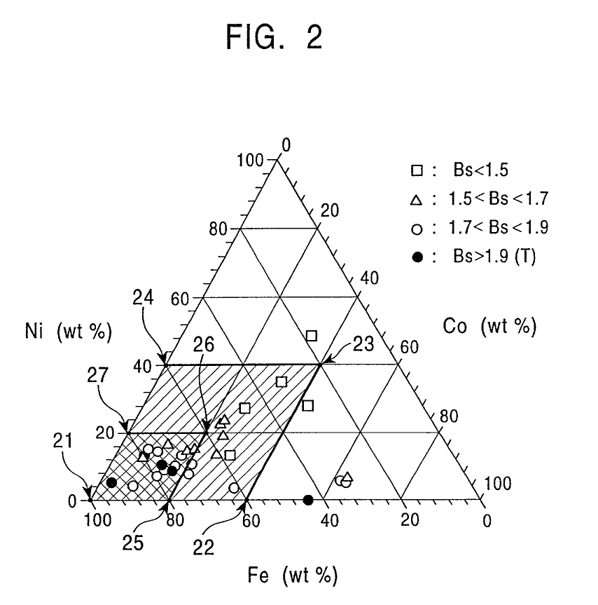

FIG. 2 is a ternary diagram showing the relation between the composition ratio of each of Co, Fe and Ni and saturation magnetic flux density when S (sulfur) is selected as element X, and the composition ratio of S to all component elements is fixed to 1 wt %. The composition ratio of each of Co, Fe and Ni is represented on the assumption that the remainder is 100 wt % excluding the composition ratio (1 wt %) of S.

FIG. 2 indicates that as the composition ratio (wt %) of Fe increases, and the composition ratio (wt %) of Ni decreases, the saturation magnetic flux density Bs increases. In the present invention, the composition ratios of Co, Fe and Ni are preferably in the range surrounded by reference numerals 21 to 24 shown in FIG. 2. Namely, the composition ratio of Co is in the range of 0 to 40 wt %, the composition ratio of Fe is in the range of 20 wt % to 100 wt %, and the composition ratio of Ni is in the range of 0 to 40 wt %.

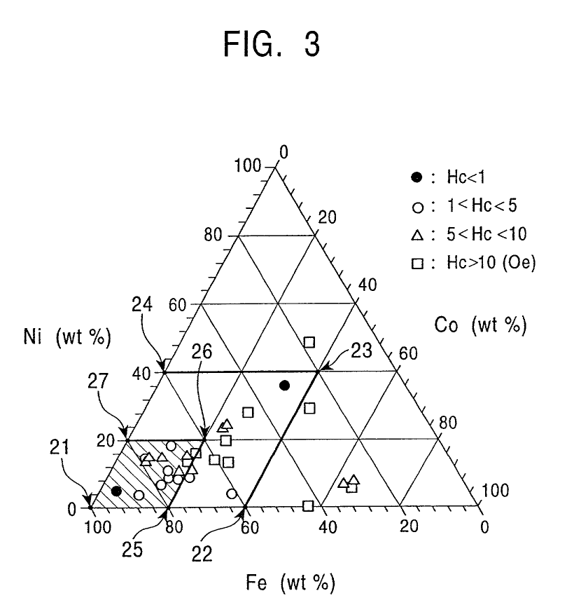

FIG. 3 is a ternary diagram showing the relation between the composition ratio of each of Co, Fe and Ni and coercive force when S (sulfur) is selected as element X, and the composition ratio of S to all component elements is fixed to 1 wt %. The composition ratio of each of Co, Fe and Ni is represented on the assumption that the remainder is 100 wt % excluding the composition ratio (1 wt %) of S.

FIG. 3 indicates that as the composition ratio of Fe increases, and the composition ratio of Ni decreases, the coercive force decreases.

Like in the case shown in FIG. 2, in order to decrease the coercive force, the composition ratios of Co, Fe and Ni are preferably in the range surrounded by reference numerals 21 to 24 shown in FIG. 3. Namely, the composition ratio of Co is in the range of 0 to 40 wt %, the composition ratio of Fe is in the range of 20 wt % to 100 wt %, and the composition ratio of Ni is in the range of 0 to 40 wt %.

Therefore, addition of element X (in FIGS. 2 and 3, 1 wt % S is added as element X) to the CoFeNi alloy can achieve a high saturation magnetic flux density with the composition ratio of each of Co, Fe, and Ni in the range (in the range surrounded by reference numerals 21 to 24), and low coercive force with the composition ratio of each of Co, Fe, and Ni in the same range. By appropriately controlling the composition ratio of each of the elements in the above-described range, the saturation magnetic flux density of the Co-Fe-Ni-X alloy can be set o 1.5 T (Tesla) or more, and the coercive force can be set to 10 Oe (Oested) or more.

In the present invention, in order to attain a saturation magnetic flux density Bs of 1.7 T or more, and a coercive force of 5 Oe or less, the composition ratios are more preferably in the range surrounded by reference numerals 21, 15, 26 and 27 shown in FIGS. 2 and 3. Namely, the composition ratio of Co is in the range of 0 to 20 wt %, the composition ratio of Fe is in the range of 60 wt % to 100 wt %, and the composition ratio of Ni is in the range of 0 to 20 wt %.

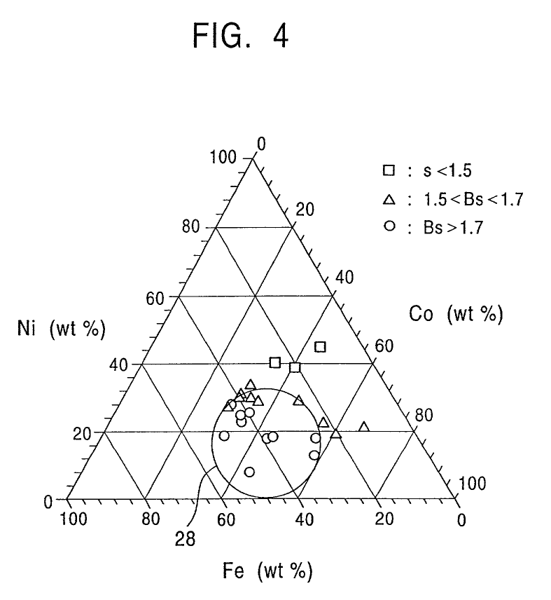

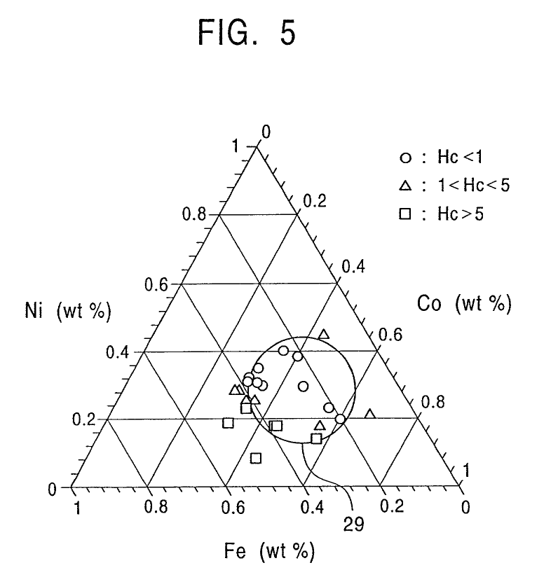

FIGS. 4 and 5 are ternary diagrams showing the relations between the composition ratio of each element and saturation magnetic flux density (FIG. 4) and coercive force (FIG. 5), respectively, of a conventional soft magnetic film as a comparative example.

FIG. 4 reveals that in order to obtain a saturation magnetic flux density of 1.5 T or more, for example, the composition ratios of Co, Fe and Ni are preferably set to ratios in the circle shown by reference numeral 28 in FIG. 4.

FIG. 5 reveals that in order to obtain a coercive force of 5 Oe or less, for example, the composition ratios of Co, Fe and Ni are preferably set to ratios in the circle shown by reference numeral 29 in FIG. 5.

As a result of study of the positional relationship, in the ternary diagrams, between the composition ratio range 28 for high saturation magnetic flux density shown in FIG. 4 and the composition ratio range 29 for low coercive force shown in FIG. 5, it was found that both composition ratio ranges 28 and 29 are deviated from each other.

Namely, with the CoFeNi alloy, in order to obtain a high saturation magnetic flux density, the coercive force cannot be decreased so much, while in order to obtain low coercive force, the saturation magnetic flux density cannot be increased so much. It is thus found to be difficult to simultaneously obtain a high saturation magnetic flux density and low coercive force.

As described above, with the CoFeNiX alloy of the present invention, the composition range (refer to FIG. 2) for obtaining a high saturation magnetic flux density overlaps the composition range (refer to FIG. 3) for obtaining low coercive force, thereby permitting achievement of both a high saturation magnetic flux density and low coercive force at the same time.

In the present invention, improvement in resistivity is expected by adding nonmetallic element X (at least one element selected from S, P, B, C, and N) to the CoFeNi alloy. Also the addition of element X possibly influences soft magnetic properties other than resistivity, such as coercive force, etc. according to the adding amount.

In the present invention, for example, in order to contain S (sulfur) as element X in the soft magnetic film composed of Co, Fe and Ni, S can be contained in a plating solution containing Co ions, Fe ions, and Ni ions by adding thiourea (composition: CH₄N₂S) to the plating solution.

For element X other than S, in order to contain element X in the soft magnetic film composed of Co, Fe and Ni, a soluble compound of element X may be added to the plating solution containing Co ions, Fe ions, and Ni ions. For example, with P (phosphorus) selected as element X, additive compounds includes phosphorous acid (H₃PO₃), hypophosphorous acid (H₃PO₂), and the like.

In experiment, 0.86 g/l of Co ion, 6.5 g/l of Fe ion, and 9.8 g/l of Ni ion were charged in each of three plating solutions, and thiourea was added to the plating solutions at different concentrations of 40 mg/l. 70 mg/l and 170 mg/l.

Resistivity ρ and the concentrations wt % of Co, Fe, Ni and S soft magnetic film were measured with each of the amounts of thiourea added. The results are summarized in Table 1. In Table 1, the composition ratio of each of the elements is represented by a ratio to all component elements.

TABLE 1

| Thiourea | ρ | | | | |
|---|---|---|---|---|---|
| (mg/l) | (μΩ · cm) | Co (wt %) | Ni (wt %) | Fe (wt %) | S (wt %) |
| 40 | 33.7 | 21.8 | 24.5 | 52.7 | 1 |
| 70 | 37.0 | 22.2 | 25.4 | 51.2 | 1.2 |
| 170 | 46.1 | 20.5 | 24.5 | 53.4 | 1.6 |

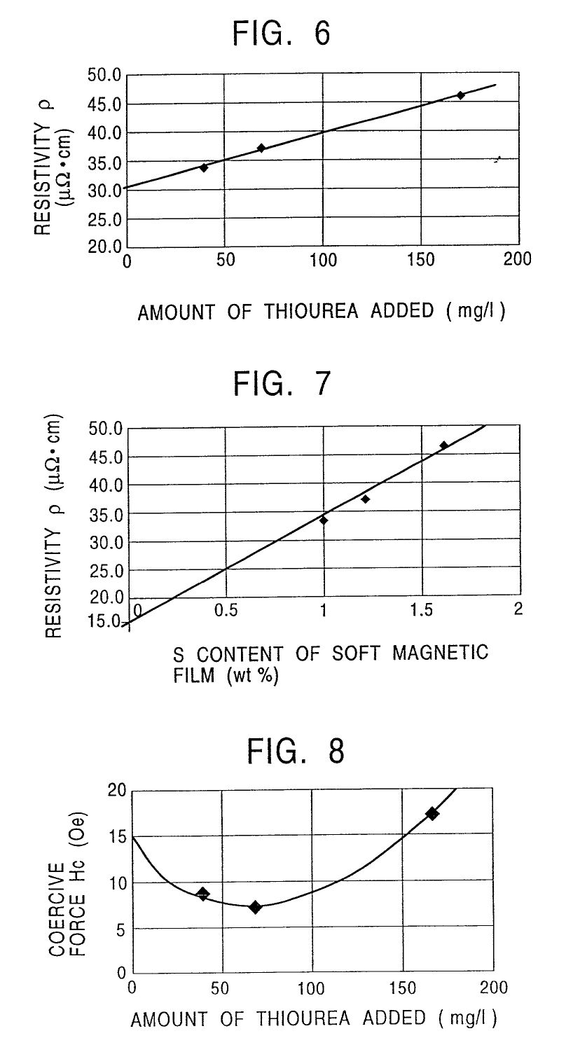

On the basis of the experimental results, the relation between the amount (mg/l) of thiourea added and resistivity ρ, and the relation between the S concentration (wt %) of the soft magnetic film and resistivity ρ are shown in FIGS. 6 and 7, respectively.

FIG. 6 indicates that resistivity can be increased by increasing the amount of thiourea added. Table 1 shows that as the amount of thiourea added increases, the S concentration of the soft magnetic film increases, and FIG. 7 shows that as the S concentration increases, resistivity ρ increases. FIGS. 6 and 7 also reveal that resistivity ρ substantially linearly changes with the amount of thiourea added and the S concentration of the soft magnetic film. Since S is nonmetallic, resistivity ρ is possibly increased by adding only S.

The resistivity ρ of the CoFeNi alloy used in a conventional core layer is about 20 μΩ.cm at most, and thus in order to obtain a resistivity ρ higher than this value, in the present invention, the S concentration (=concentration of element X) of the soft magnetic film is set to 0.5 wt % or more, preferably 1.0 wt % or more.

Next, three samples having the different amounts of thiourea added were used for measuring coercive force Hc and the concentrations wt % of Co, Fe, Ni and S of a soft magnetic film with each of the amounts of thiourea added. The results are summarized in Table 2. In Table 2, the composition ratio of each of the elements is represented by a ratio to all component elements.

TABLE 2

| Thiourea | | | | | |
|---|---|---|---|---|---|
| (mg/l) | Hc (Oe) | Co (wt %) | Ni (wt %) | Fe (wt %) | S (wt %) |
| 40 | 8.86 | 21.8 | 24.5 | 52.7 | 1 |
| 70 | 7.213 | 22.2 | 25.4 | 51.2 | 1.2 |
| 170 | 17.73 | 20.5 | 24.5 | 53.4 | 1.6 |

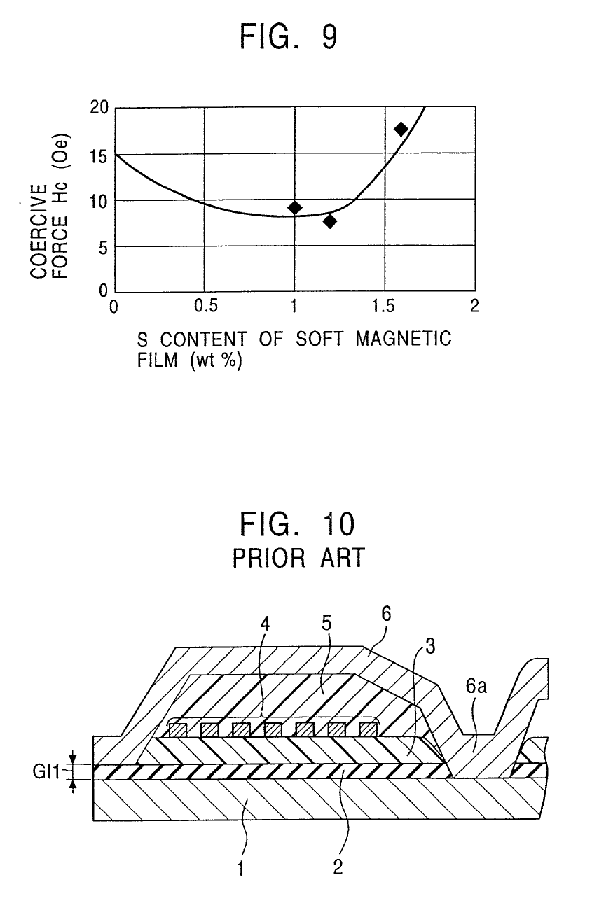

On the basis of the experimental results, the relation between the amount (mg/l) of thiourea added and coercive force Hc, and the relation between the S concentration (wt %) of the soft magnetic film and coercive force Hc are shown in FIGS. 8 and 9, respectively.

FIG. 8 indicates that coercive force Hc can be decreased by adding a predetermined amount of thiourea. However, with an amount larger than the predetermined amount, coercive force Hc is increased.

From the viewpoint of the relation between the S concentration of the soft magnetic film and coercive force, FIG. 9 shows the same tendency as FIG. 8 that the coercive force can be effectively decreased by increasing the S concentration to a predetermined value. However, with the S concentration higher than that value, coercive force Hc is increased.

Addition of S to some extent can possibly accelerate decrease in the crystal grain size to effectively decrease coercive force Hc, while addition of a predetermined amount or more of S possibly increases the crystal gain size to increase coercive force Hc.

In the present invention, coercive force Hc is preferably as low as possible, and thus the S concentration of the soft magnetic film is 2 wt % or less, more preferably 1.5 wt % or less.

On the basis of the experimental results shown in FIGS. 6 to 9, therefore, the composition ratio of element X is preferably in the range of 0.5 wt % to 20 wt %, more preferably in the range of 1.0 wt % to 1.5 wt %.

Even when the concentration of element X is set to 2 wt % or less, addition of about 1.3 wt % or more of S increases coercive force Hc to 10 Oe or more, as shown in FIG. 9. However, the coercive force Hc can be decreased by appropriately adjusting the composition ratios Co, Fe and Ni which constitute the soft magnetic film, as shown in FIG. 3.

Namely, combination of the proper composition ratios of Co, Fe and Ni shown in FIGS. 2 and 3, and the proper composition ratio of element X shown in FIGS. 6 to 9 permits the formation of a soft magnetic film having excellent soft magnetic properties such as a high saturation magnetic flux density, high resistivity and low coercive force.

As described above, in the present invention, the lower core layer 15 and/or the upper core layer 20 shown in FIG. 1 comprises a soft magnetic film represented by the composition formula CoₐFe_{b}Ni_{c}X_{d} wherein element X is at least one element selected from S, P, B, C, and N, the composition ratio d of element X to all component elements is in the range of 0.5 wt % to 2 wt %, and when the remainder is 100 wt % excluding the composition ratio d, composition ratio a is in the range of 0 to 40 wt %, composition ratio b is in the range of 20 wt % to 100 wt %, and composition ratio c is in the range of 0 to 40 wt %.

More preferably, the composition ratio d is in the range of 1 wt % to 1.5 wt %, the composition ratio a is in the range of 0 to 20 wt %, the composition ratio b is in the range of 60 wt % to 100 wt %, and the composition ratio c is in the range of 0 to 20 wt %.

In the present invention, a CoFeNiX alloy having high resistivity is used for the lower core layer 15 and/or the upper core layer 20 of the thin film magnetic head to decrease an eddy current loss even with a higher recording frequency. In addition, since the CoFeNiX alloy has a high saturation magnetic flux density and low coercive force, it is possible to manufacture a thin film magnetic head capable of complying with increases in recording density and recording frequency in the future.

In an example, a thin film magnetic head was manufactured, in which the lower core layer 15 was made of a Ni₈₂Fe₁₈ alloy (composition ratio wt %), and the upper core layer 20 was made of a Co₁₉Fe₇₂Ni₈S₁ alloy (composition ratio wt %). In a comparative example, a thin film magnetic head was manufactured, in which the lower core layer 15 was made of a Ni₈₂Fe₁₈ alloy (composition ratio wt %), and the upper core layer 20 was made of a Fe₅₀Ni₅₀ alloy (composition ratio wt %) or a Co₃₁Fe₃₉Ni₃₀ alloy (composition ratio wt %). Overwrite performance of these thin film magnetic heads was examined.

The overwrite performance is shown by a reproduced output value after recording at a low frequency and then overwrite at a high frequency. In experiment, recording was carried out at a low frequency of 7.5 MHz, and then overwrite was carried out at a high frequency of 60 MHz to measure reproduced output.

In the thin film magnetic head of the example, the overwrite performance is 44.3 dB, while in the thin film magnetic head of the comparative example, the overwrite performance was 39.3 dB. These experimental results indicate that the over write performance of the core layer made of the CoFeNiS alloy can be improved, i.e., recording properties can be improved, as compared with the core layer made of the CoFeNi alloy or FeNi alloy.

As described above, in the present invention, element X (at least one element selected from S, P, B, C and N) is added at a composition ratio d to a CoₐFe_{b}Ni_{c} alloy to form a soft magnetic film having soft magnetic properties such as high resistivity and low coercive force while maintaining a high saturation magnetic flux density.

Specifically, the composition ratio d of element X to all component elements is in the range of 0.5 wt % to 2 wt %, and when the remainder is 100 wt % excluding the composition ratio d, the composition ratio a is in the range of 0 to 40 wt %, the composition ratio b is in the range of 20 wt % to 100 wt %, and the composition ratio c is in the range of 0 to 40 wt %.

More preferably, the composition ratio d is in the range of 1 wt % to 1.5 wt %, the composition ratio a is in the range of 0 to 20 wt %, the composition ratio b is in the range of 60 wt % to 100 wt %, and the composition ratio c is in the range of 0 to 20 wt %.

A CoFeNiX alloy having soft magnetic properties such as a high saturation magnetic flux density, high resistivity and low coercive force is used for a lower core layer and/or an upper core layer of a thin film magnetic head to decrease an eddy current loss even with a higher recording frequency, thereby permitting manufacture of a thin film magnetic head capable of complying with increased in recording density and recording frequency in the future.

What is claimed is:

1. A soft magnetic film represented by the composition formula CoₐFe_{b}Ni_{c}X_{d} wherein element X is at least one element selected from S, P, B, C, and N, the composition ratio d of element X to all component elements is in the range of 0.5 wt % to 2 wt %, and when the remainder is 100 wt % excluding the composition ratio d, composition ratio a is in the range of more than 0 wt % and less than 40 wt %, composition ratio b is in the range of 20 wt % to 100 wt %, and composition ratio c is in the range of more than 0 wt % and less than 40 wt %.

2. A soft magnetic film according to claim 1, wherein the composition ratio d is in the range of 1 wt % to 1.5 wt %.

3. A soft magnetic film according to claim 1, wherein the composition ratio a is in the range of more than 0 wt % and less than 20 wt %, the composition ratio b is in the range of 60 wt % to 100 wt %, and the composition ratio c is in the range of more than 0 wt % and less than 20 wt %.

4. A soft magnetic film according to claim 1, wherein the saturation magnetic flux density is 1.5 T or more.

5. A soft magnetic film according to claim 1, wherein the resistivity is 20 μΩ.cm or more.

6. A soft magnetic film according to claim 1, wherein the coercive force is 10 Oe or less.

7. A soft magnetic film according to claim 3, wherein the saturation magnetic flux density is 1.7 T or more.

8. A soft magnetic film according to claim 3, wherein the coercive force is 5 Oe or less.

9. A method of producing a soft magnetic film comprising adding thiourea (CH₄N₂S) to a plating solution containing Co ions, Fe ions, and Ni ions to contain S in the plating solution when element X which constitutes a soft magnetic film according to any one of claims 1 to 8 is S.

10. A thin film magnetic head comprising a lower core layer made of a magnetic material, an upper core layer opposed to the lower core layer with a magnetic gap formed therebetween on a side facing a recording medium, and a coil layer for inducting a recording magnetic field in both core layers, wherein the upper core layer and/or the lower core layer comprises a soft magnetic film according to any one of claims 1 to 8.
